(19) United States
(12) Patent Application Publication
(10) Pub. No.: US 2008/0229204 A1
(43) Pub. Date: Sep. 18, 2008

(54) Apparatus, System And Method For The Navigation Of Aggregated Content Using Skipping And Content Metadata

(76) Inventors: Brian David Johnson, Portland, OR (US); Sean Dunnahoo, Portland, OR (US); Christie Flynn, Hillsboro, OR (US)

Correspondence Address: Molly A. McCall;Intel Corporation, Intel Corporation, c/o Intellevate, LLC, P.O.Box 52050, Minneapolis, MN, 55402, US

(21) Appl. No.: 11/685,081

(22) Filed: Mar. 12, 2007

(51) Int. Cl. G06F 3/00; G06F 3/048

(52) U.S. Cl. 715/721; 715/817

(57) ABSTRACT

Apparatus, system and method for the navigation of aggregated content using skipping and content metadata. An apparatus includes a processor to receive a control signal from a navigation controller and to display a skip function user interface on a display device. The skip function user interface is used to navigate aggregated content items and includes one or more skip boxes. Each of the one or more skip boxes is associated with a content item in the aggregated content items. Other embodiments are described and claimed.

### BACKGROUND

The introduction of digital content into today's homes creates new challenges and opportunities for content providers and consumers. For example, today's homes may have one or more electronic devices that process and/or store content, such as personal computers (PCs), televisions, digital video disk; (DVD) players, video cassette recorder (VCR) players, compact disk (CD) players, set-top boxes, stereo receivers, audio/video receivers (AVRs), media centers, personal video recorders (PVRs), gaming devices, digital camcorders, digital cameras, and so forth. These all may be networked together in such away to provide a user with a means for entertainment via the home entertainment center and a single display device.

A television user Interface (such as a remote control) and channel guide may be used to provide commands in order to search for content available via networked devices. In some cases, a user may aggregate selected content to make it more easily available via a personal channel. However, navigation and/or manipulation of a today's user interfaces are slow and confusing via a standard television remote control. Unfortunately, the television experience is typically via a “lean back” mode, where the user does not want to or cannot interact (due to input device limitations) with the television at the same intensity as is possible when using a PC.

### BRIEF DESCRIPTION OF THE DRAWINGS

FIG. 1 illustrates one embodiment of a user interface.

FIG. 2 illustrates one embodiment of a user interface.

FIG. 3 illustrates one embodiment of a user interface.

FIG. 4 illustrates one embodiment of a navigation controller.

FIG. 5 illustrates one embodiment of a system.

FIG. 6 illustrates one embodiment of a logic flow.

FIG. 7 illustrates one embodiment of a device.

### DETAILED DESCRIPTION

Various embodiments may be generally directed to a user interface that allows for the navigation of aggregated content using skipping and content metadata. In an embodiment of the invention, content may Include, but is not limited to, shows or programs, voice, audio, music, graphics, video games, books, video shorts, video previews, news clips, news highlights, family pictures, and so forth. The content may be broadcasted, pre-recorded and stored on a digital recording device (such as a personal video recorder (PVR)), streamed or downloaded via the Internet, stored on a home local area network (LAN) (such as in a networked home entertainment system), and so forth.

A user may create a personal channel where content may be aggregated and then made accessible via the personal channel. The aggregated content may be displayed to the user via a playlist or queue. Typical playlists display a listing of all of the aggregated content in the personal channel and are not easily navigated.

In an embodiment of the invention, a skip or navigate function user interface is provided for the user to more easily navigate the aggregated content in a personal channel. The skip function user interface may contain one or more skip boxes. Here, each skip box is populated in such a way as to represent one content item in the aggregated content.

The skip box may be populated with metadata for the particular content item. Examples of the metadata may include, but are not limited to, visual cues such as logos, thumbnail photos and/or text that are related to the content item.

The populated skip boxes may also be arranged in a visual timeline for content to be broadcast, for example. Here, in embodiments of the invention, the populated skip boxes are organized and displayed to the user in such an order as to easily allow the user to determine which content will start broadcasting first, which content will start broadcast second, and so forth.

A highlighted skip box may result in its associated content being displayed full-screen on a display device. The skip function user interface may also indicate the time remaining for the currently highlighted content item or skip box. The skip function user interface also provides an easy way for the user to more easily reach his or her desired content by skipping, forwarding or jumping to it.

In embodiments of the invention, skip function user interface 202 allows a user to view dozens or scores of content items in a personal channel that will be played in sequence on a television via a “lean-back” consumption mode. Here, skip function user interface 202 provides the user with clear indications of where he or she is within the viewing of the personal channel stream (and thus dozens of content items).

Other embodiments may be described and claimed.

Various embodiments may comprise one or more elements. An element may comprise any structure arranged to perform certain operations. Each element may be implemented as hardware, software, or any combination thereof, as desired for a given set of design parameters or performance constraints. Although an embodiment may be described with a limited number of elements in a certain topology by way of example, the embodiment may include more or less elements in alternate topologies as desired for a given implementation. It is worthy to note that any reference to “one embodiment” or “an embodiment” means that a particular feature, structure, or characteristic described in connection with the embodiment is included in at least one embodiment. The appearances of the phrase “in one embodiment” in various places in the specification are not necessarily all referring to the same embodiment.

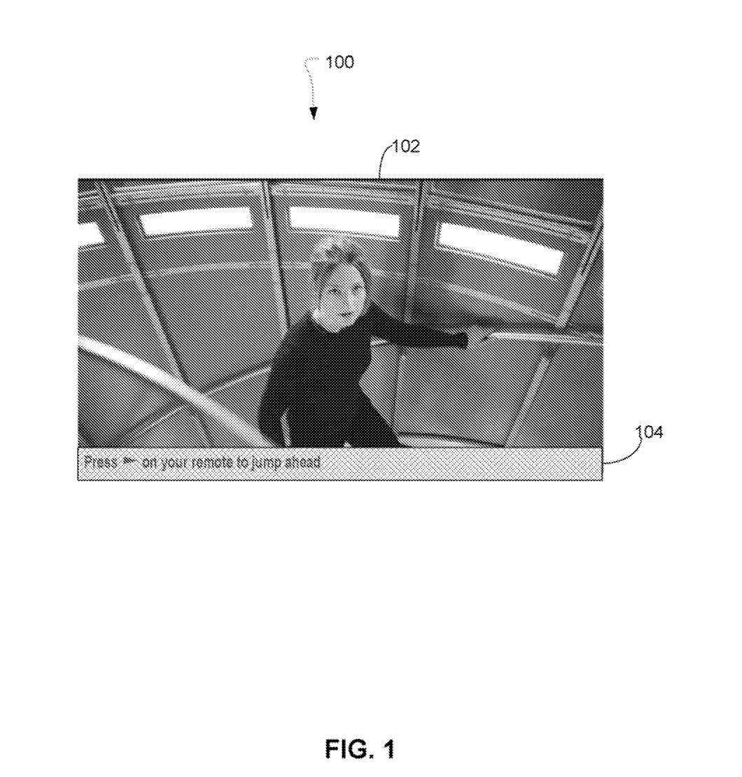

FIG. 1 illustrates one embodiment of a user interface 100. User interface 100 may comprise a video/picture section 102 and a message section 104. User interface 100 may be displayed on a display device, for example. Each of these sections is described next in more detail.

Video/Picture section 102 displays content, where the content may include shows or programs, graphics, video games, books, video shorts, video previews, news clips, news highlights, family pictures, and so forth. In an embodiment, the content may be received via one or more of broadcast, cable and satellite television feeds. Related voice, audio, music, etc., may also be presented with the displayed content in section 102.

In an embodiment, message section 104 prompts the user to activate the skip function of the present invention. For example, the skip function may be activated via pressing a button on a television remote control. Message section 104 is typically placed on the bottom of user interface 100, although the invention is not limited in this regard.

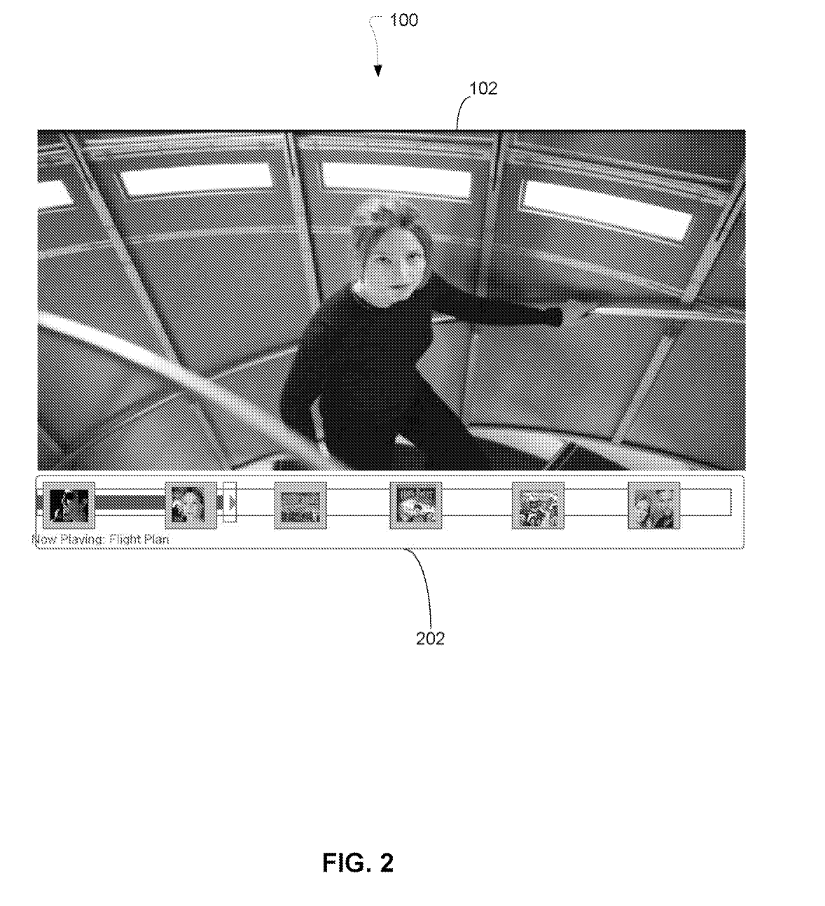

Once the skip function is activated, a skip function user interface 202 is displayed on user interface 100, as is illustrated in FIG. 2. Skip function user interface 202 may replace message section 104 on user interface 100, although the invention is not limited in this regard.

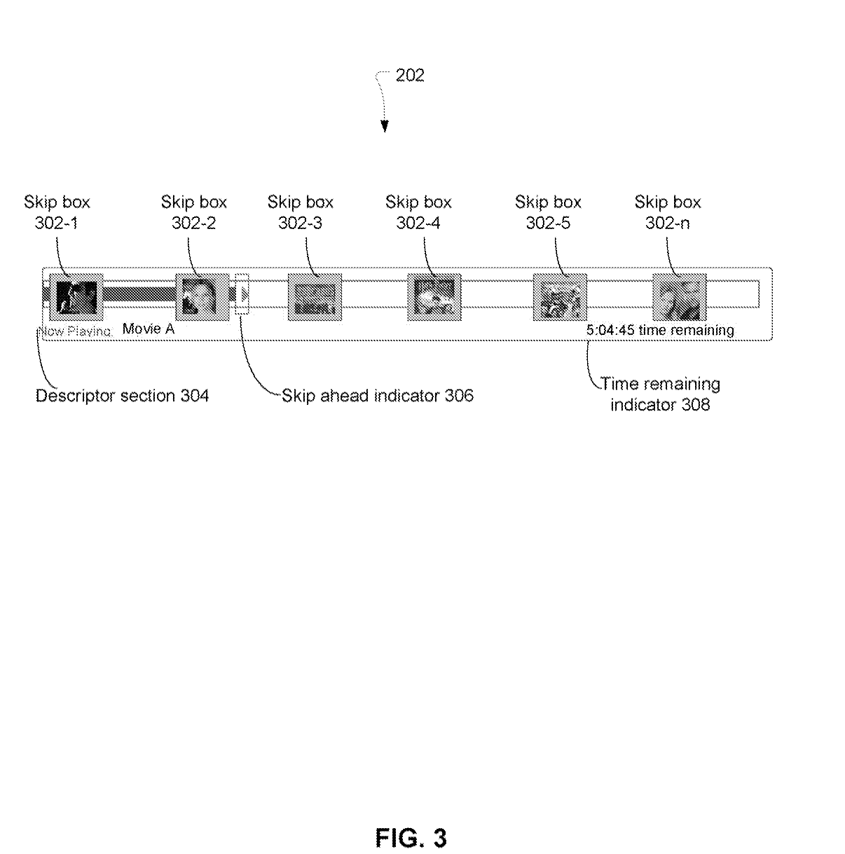

FIG. 3 illustrates an embodiment of skip function user interface 202 in more detail. Skip function user interface 202 may have one or more virtual keys that may be activated by the user to perform the functions. Referring to FIG. 3, skip function user interface 202 may include one or more skip boxes 302-1 to 302-n, where n is any positive integer. User interface 202 may also include a descriptor section 304, a skip ahead indicator 306 and a time remaining indicator 308. Each of these elements or components of skip function user interface 202 is described next in more detail.

As discussed above, a user may create a personal channel where content may be aggregated and then made accessible via the personal channel. The aggregated content may be displayed to the user via a playlist or queue. Typical playlists display a listing of ail of the aggregated content in the personal channel and are not easily navigated. Skip function user interface 202 may be used to more easily navigate the aggregated content in a personal channel.

Skip boxes 302-1 to 302-n are each populated with metadata that represent a content item in the personal channel. Examples of the metadata may include, but are not limited to, visual cues such as logos, thumbnail photos and/or text that are related to the content item.

The populated skip boxes may also be arranged in a visual timeline for content to be broadcast, for example. Here, in embodiments of the invention, the populated skip boxes are organized and displayed to the user in such an order as to easily allow the user to determine which content will start broadcasting first, which content will start broadcast second, and so forth. A highlighted skip box may result in its associated content being displayed full-screen on a display device.

Descriptor section 304 informs the user of the content currently being displayed in video/picture section 102 (FIGS. 1 and 2). As illustrated in FIG. 3, descriptor section 304 may display the title of the current content item highlighted and thus currently being displayed full-screen in video/picture section 102. Descriptor section 304 may provide related guide data such as content name, channel or location (e.g., location on the Internet via an Internet Protocol (IP) address or Uniform Resource Location (URL), location on a local hard disk, etc.), type of content (e.g., broadcast, stream, download, etc.), metadata (e.g., content description, year of release, ratings information, category, etc.), air time, a brief synopsis, stars, and so forth. These examples are not meant to limit the invention.

Skip ahead indicator 306 provides an easy way for the user to more easily reach his or her desired content by skipping, forwarding or jumping through skip boxes 302-1 to 302-n. Although not shown in FIG. 3, user interface 202 may also include a skip back indicator.

Time remaining indicator 308 indicates the time remaining (if applicable) for the currently highlighted content item or skip box. In an embodiment, the highlighted content item or skip box is what is currently being displayed full-screen in a video/picture section 102.

In embodiments of the invention, skip function user interface 202 allows a user to view dozens or scores of content items in a personal channel that will be played in sequence on a television via a “lean-back” consumption mode. Here, skip function user interface 202 provides the user with clear indications of where he or she is within the viewing of the personal channel stream (and thus dozens of content items).

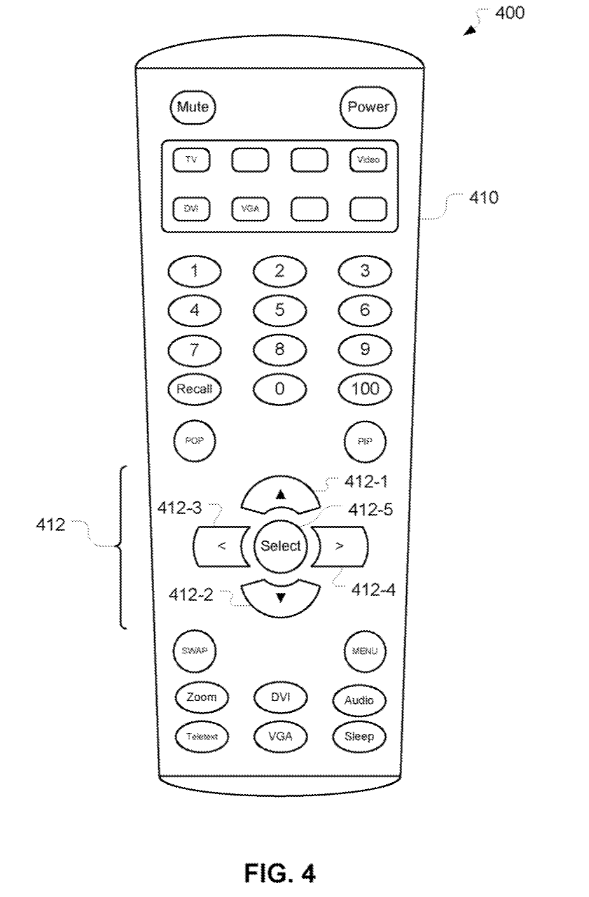

The virtual keys or functionality of skip function user interface 202 may be activated by a user via a navigation controller. In one embodiment, the navigation controller may be a pointing device or remote control, as described with reference to FIG. 4. Referring to FIG. 4, one embodiment of a navigation controller 400 is shown. Pointing device 410 may be any computer hardware component (specifically human interface device) that allows a user to input spatial (i.e., continuous and multi-dimensional) data into a computer. Many systems such as computer aided design (CAD), graphical user interfaces (GUI), and televisions and monitors allow the user to control and provide data to the computer or television using physical gestures—point, click, and drag—typically by moving wired or wireless pointing device such as a mouse, trackball, touchpad, pointing stick, light pen, joystick, head pointer, eye tracking device, digitizing tablet, data glove, remote controller, among others. Movements of pointing device 410 are echoed on a display device by movements of a pointer, cursor, focus ring, or other visual indicators displayed on the display device.

In the illustrated embodiment, pointing device 410 is a conventional remote control unit used to interact with audio/visual devices such as televisions, monitors, cable boxes, digital video disc (DVD) player, compact disc (CD) players, digital video recorders (DVR), video games, digital video camera, and/or digital still camera, among others, for example. Pointing device 410 comprises navigation buttons 412. In one embodiment, the navigation buttons 412 comprise an upward navigation button 412-1, a downward navigation button 412-2, a leftward navigation button 412-3, and a rightward navigation button 412-4. Navigation buttons 412 also may comprise a select button 412-5 to execute a particular function. Pointing device 410 may be a wireless remote that operates on wireless principles employing infra-red (IR) energy or radio frequency (RF) energy. In other embodiments, pointing device 410 may be hard wired to the display device, for example. The embodiments, however, are not limited to the elements or in the context shown or described in FIG. 4.

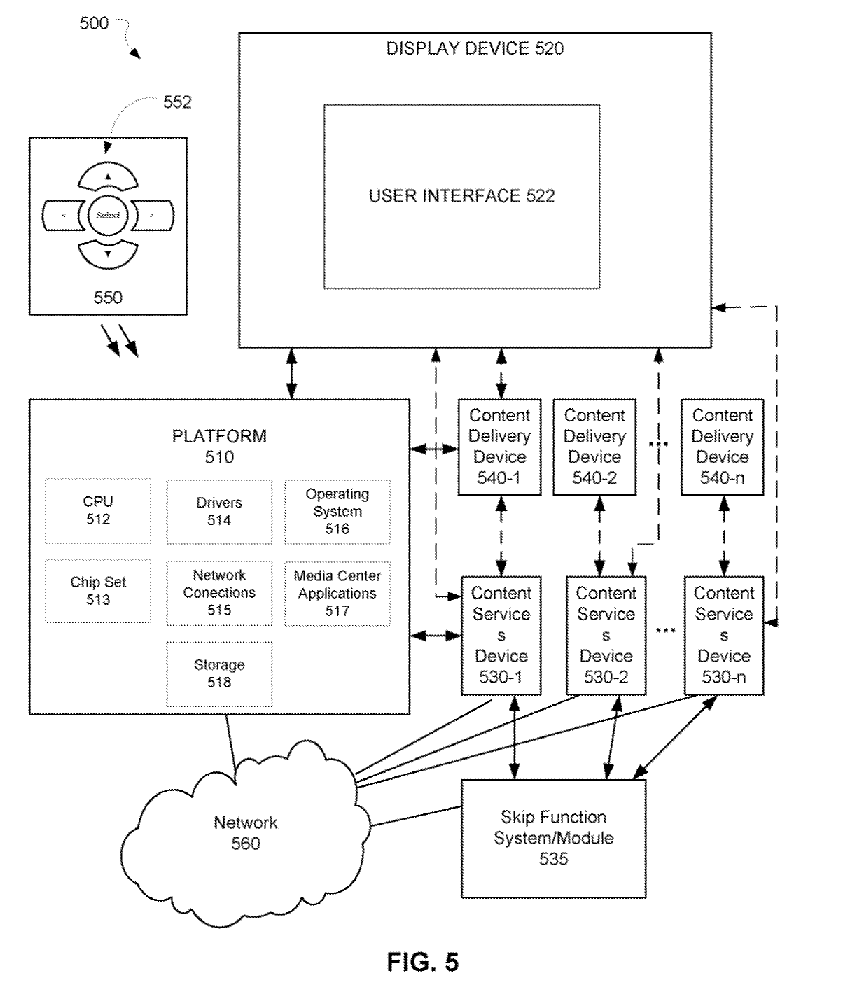

FIG. 5 illustrates one embodiment of a system 500. In one embodiment, system 500 may be a digital home entertainment system although system 500 is not limited in this context. In one embodiment, system 500 comprises a platform 510 coupled to a display device 520. In one embodiment, platform 510 may comprise or may be implemented as a media platform such as the Viiv™ media platform made by Intel® Corporation. In one embodiment, platform 510 may receive content from one or more content devices such as content services devices 530 (530-1 to 530-m, where m is any positive integer) or one or more content delivery devices 540 (540-1 to 540-p, where p is any positive integer) or other similar content source. In an embodiment of the invention, one or more of content services devices 530 may be hosted by any national, international and/or independent service and thus accessible to platform 510 via the Internet. One or more of content services devices 530 may be coupled to platform 510 and/or to display device 520. Platform 510 and/or content services devices 530 may be coupled to a network 560 to communicate (e.g., send and/or receive) media information to and from network 560. One or more of content delivery devices 540 also may be coupled to platform 510 and/or to display device 520.

In various embodiments, one or more of content services devices 530 may be coupled (e.g., either directly or via network 560) to a skip function system/module system/module 535. Skip function system/module 535 may contain one or more software applications to perform the functionality of skip function user interface 202, as described herein. The content and/or service providers may utilize skip function system/module 535 to provide content and associated metadata for one or more of their products or services. The functionality and stored content/metadata of skip function system/module 535 may also be integrated directly in platform 510.

Content and/or service providers may utilize one or more of content services devices 530 to provide services and/or products to a user via user interface 522 (or via user interface 100 in FIG. 1).

In various embodiments, platform 510 and one or more of content services devices 530 may be integrated, or platform 510 and one or more of content delivery devices 540 may integrated, or platform 510, one or more of content services devices 530, and one or more of content delivery devices 540 may be integrated, for example. In various embodiments, platform 510 and display device 520 may be an integrated unit and display device, or one or more of content service devices 530 may be integrated, or display device 520 and one or more of content delivery devices 540 may integrated. A navigation controller 550 comprising one or more navigation buttons 552 may be used to interact with either platform 510 or display device 520, and/or both, for example.

In one embodiment, platform 510 may comprise a CPU 512, a chip set 513, one or more drivers 514, one or more network connections 515, an operating system 516, and/or a media center application 517 comprising one or more software applications, for example. Platform 510 also may comprise storage 518. Storage 518 may include control and content data used to define the functionality and metadata associated with skip function user interface 202.

In one embodiment, CPU 512 may comprise one or more processors such as dual-core processors. Examples of dual-core processors include the Pentium® D processor and the Pentium® processor Extreme Edition both made by Intel® Corporation, which may be referred to as the Intel Core Duo processors, for example.

In one embodiment, chip set 513 may comprise any one of or all of the Intel® 945 Express Chipset family, the Intel® 955X Express Chipset, Intel® 975X Express Chipset family, plus ICH7-DB or ICH7-MDH controller hubs, which all are made by Intel® Corporation.

In one embodiment, drivers 514 may comprise the Quick Resume Technology Drivers made by Intel® to enable users to instantly turn on and off platform 510 like a television with the touch of a button after initial boot-up, when enabled, for example. In addition, chip set 513 may comprise hardware and/or software support for 5.1 surround sound audio and/or high definition 7.1 surround sound audio, for example. Drivers 514 may include a graphics driver for integrated graphics platforms. In one embodiment, the graphics driver may comprise a peripheral component interconnect (PCI) Express graphics card.

In one embodiment, network connections 515 may comprise the PRO/1000 PM or PRO/100 VE/VM network connection, both made by Intel® Corporation.

In one embodiment, operating system 516 may comprise the Windows® XP Media Center made by Microsoft® Corporation. In one embodiment, one or more media center applications 517 may comprise a media shell to enable users to interact with content using navigation controller 550 (e.g., remote control) from a distance of about 10-feet away from platform 510 or display device 520, for example. In one embodiment, the media shell may be referred to as a “10-feet user interface,” for example. In addition, one or more media center applications 517 may comprise the Quick Resume Technology made by Intel®, which allows instant on/off functionality and may allow platform 510 to stream content to media adaptors or other content services devices 530 or content, delivery devices 540 when the platform is turned “off.”

In one embodiment, storage 518 may comprise the Matrix Storage technology made by Intel® to increase the storage performance enhanced protection for valuable digital media when multiple hard drives are included.

In one embodiment, display device 520 may comprise any television type monitor or display. Display device 520 may comprise, for example, a computer display screen, video monitor, television-like device, and/or a television. Display device 520 may be digital and/or analog.

In various embodiments, one or more of content services devices 530 may comprise a cable television box, personal computer, network, telephone, Internet enabled devices or appliance capable of delivering digital information and/or content, and any other similar device capable of unidirectionally or bidirectionally communicating content between content providers and platform 510 and/display device 520, via network 560. It will be appreciated that the content may be communicated unidirectionally and/or bidirectionally to and from any one of the components in system 500 and a content provider via network 560. Examples of content may include any media information including, for example, video, music, and gaming information. One or more of content services devices 530 may receive content such as cable television programming including media information, digital information, and/or other content. Examples of content providers may include any cable or satellite television or radio content providers and may include, for example, ESPN, Movielink, and MTV Overdrive for video; Napster, AOL and Tiscali for music; Gametap, Square Enix and T-Online for gaming; and YouTube and Flickr for sharing services.

In various embodiments, one or more of content delivery devices 540 may comprise a DVD player, CD player, DVR, video game, digital video camera, digital still camera, and/or MP3 (MPEG-1 Audio Layer 3 where MPEG stands for Moving Pictures Experts Group) player, among others, for example.

Platform 510 may receive content from network 560 directly or via one or more of content services devices 530. Platform 510 may receive content from one or more of content delivery devices 540. Under the control of one or more software applications, such as media center application 517, platform 510 displays user interface 522 (e.g., user interface 100 and/or skip function user interface 202) on display device 520.

In one embodiment, platform 510 may receive control signals from navigation controller 550 (e.g., navigation controller 400 of FIG. 4). Navigation buttons 552 (e.g., navigation buttons 412 of FIG. 4) may be used to interact with user interface 522. For example, under the control of software applications, e.g., media center applications 517, navigation buttons 552 located on navigation controller 550 may be mapped to the virtual navigation keys of skip function user interface 202.

In various embodiments, system 500 may be implemented as a wireless system, a wired system, or a combination of both. When implemented as a wireless system, system 500 may include components and interfaces suitable for communicating over a wireless shared media, such as one or more antennas, transmitters, receivers, transceivers, amplifiers, filters, control logic, and so forth. An example of wireless shared media may include portions of a wireless spectrum, such as the RF spectrum and so forth. When implemented as a wired system, system 500 may include components and interfaces suitable for communicating over wired communications media, such as input/output (I/O) adapters, physical connectors to connect the I/O adapter with a corresponding wired communications medium, a network interface card (NIC), disc controller, video controller, audio controller, and so forth. Examples of wired communications media may include a wire, cable, metal leads, printed circuit board (PCB), backplane, switch fabric, semiconductor material, twisted-pair wire, co-axial cable, fiber optics, and so forth.

Platform 510 may establish one or more logical or physical channels to communicate information. The information may include media information and control information. Media information may refer to any data representing content meant for a user. Examples of content may include, for example, data from a voice conversation, videoconference, streaming video, electronic mail (“email”) message, voice mail message, alphanumeric symbols, graphics, image, video, text and so forth. Data from a voice conversation may be, for example, speech information, silence periods, background noise, comfort noise, tones and so forth. Control information may refer to any data representing commands, instructions or control words meant for an automated system. For example, control information may be used to route media information through a system, or instruct a node to process the media information in a predetermined manner. The embodiments, however, are not limited to the elements or in the context shown or described in FIG. 5.

Operations for the above embodiments may be further described with reference to the following figures and accompanying examples. Some of the figures may include a logic flow. Although such figures presented herein may include a particular logic flow, it can be appreciated that the logic flow merely provides an example of how the general functionality as described herein can be implemented. Further, the given logic flow does not necessarily have to be executed in the order presented unless otherwise indicated. In addition, the given logic flow may be implemented by a hardware element, a software element executed by a processor, or any combination thereof.

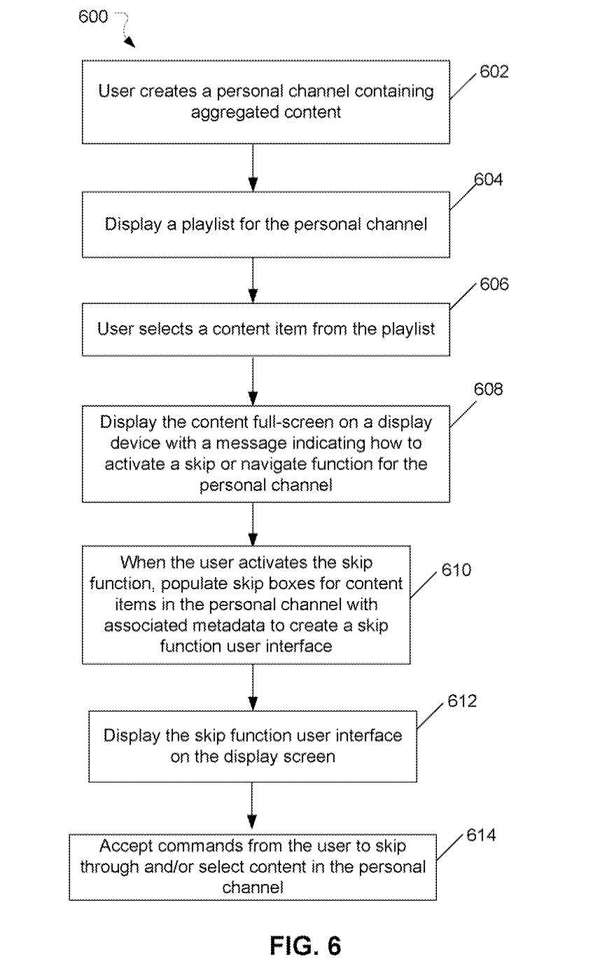

FIG. 6 illustrates one embodiment of a logic flow 600. The logic flow 600 may be representative of the operations executed by one or more embodiments described herein, for example, the operations executed by system 500. In one embodiment, logic flow 600 may be representative of the operations executed by a processor (e.g., the CPU 512) under the control of one more software applications (e.g., media center applications 517).

As shown in logic flow 600, a user creates a personal channel that contains aggregated content (block 602). As discussed above, content may include, but is not limited to, shows or programs, voice, audio, music, graphics, video games, books, video shorts, video previews, news clips, news highlights, family pictures, and so forth. The content may be broadcasted, pre-recorded and stored on a digital recording device (such as a personal video recorder (PVR)), streamed or downloaded via the Internet, stored on a home local area network (LAN) (such as in a networked home entertainment system), and so forth.

A play list is displayed for the personal channel (block 604) and the user selects a content item from the playlist (block 606). The content associated with the selected content item is displayed full-screen on a display device with a message indicating how to activate a skip or navigate function for the personal channel (block 608).

When the user activates the skip function, a skip box for each content item in the playlist is populated with metadata to create a skip function user interface, such as skip function user interface 202 of FIG. 2 (block 610). As discussed above, examples of the metadata may include, but are not limited to, visual cues such as logos, thumbnail photos and/or text that are related to the content item. The populated skip boxes may also be arranged in a visual timeline for content to be broadcast, for example. A highlighted skip box may result in its associated content being displayed full-screen on the display device.

The skip function user interface is displayed to the user on the display device (block 612). The skip function user interface accepts commands from the user to more easily reach his or her desired content by skipping, forwarding or jumping through the skip boxes (block 614). The embodiments, however, are not limited to the elements or in the context shown or described in FIG. 6.

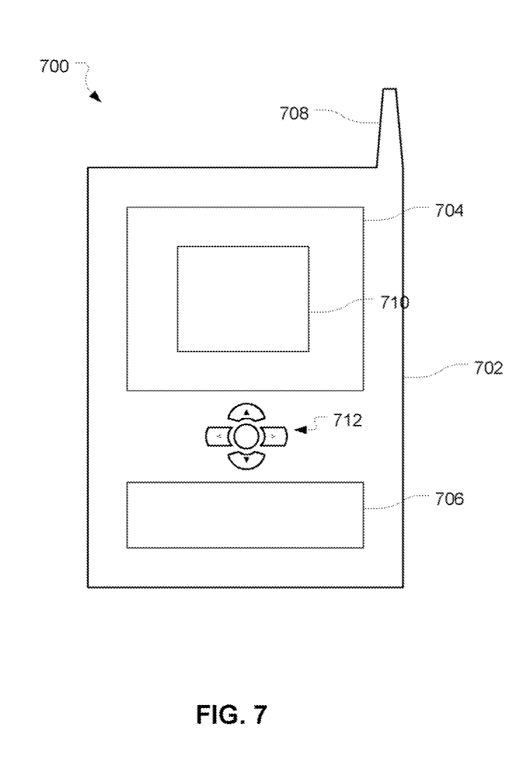

FIG. 7 illustrates one embodiment of a device 700. In one embodiment, for example, device 700 may comprise a communication system. In various embodiments, device 700 may comprise a processing system, computing system, mobile computing system, mobile computing device, mobile wireless device, computer, computer platform, computer system, computer sub-system, server, workstation, terminal, personal computer (PC), laptop computer, ultra-laptop computer, portable computer, handheld computer, personal digital assistant (PDA), cellular telephone, combination cellular telephone/PDA, smart phone, pager, one-way pager, two-way pager, messaging device, and so forth. The embodiments are not limited in this context.

In one embodiment, device 700 may be implemented as part of a wired communication system, a wireless communication system, or a combination of both. In one embodiment, for example, device 700 may be implemented as a mobile competing device having wireless capabilities. A mobile computing device may refer to any device having a processing system and a mobile power source or supply, such as one or more batteries, for example.

Examples of a mobile computing device may include a laptop computer, ultra-laptop computer, portable computer, handheld computer, palmtop computer, personal digital assistant (PDA), cellular telephone, combination cellular telephone/PDA, smart phone, pager, one-way pager, two-way pager, messaging device, data communication device, and so forth.

In one embodiment, for example, a mobile computing device may be implemented as a smart phone capable of executing computer applications, as well as voice communications and/or data communications. Although some embodiments may be described with a mobile computing device implemented as a smart phone by way of example, it may be appreciated that other embodiments may be implemented using other wireless mobile computing devices as well. The embodiments are not limited in this context.

As shown in FIG. 7, device 700 may comprise a housing 702, a display 704, an input/output (I/O) device 706, and an antenna 708. Device 700 also may comprise a five-way navigation button 712. I/O device 706 may comprise a suitable keyboard, a microphone, and/or a speaker, for example. Display 704 may comprise any suitable display unit for displaying information appropriate for a mobile computing device. I/O device 706 may comprise any suitable I/O device for entering information into a mobile computing device. Examples for I/O device 706 may include an alphanumeric keyboard, a numeric keypad, a touch pad, input keys, buttons, switches, rocker switches, voice recognition device and software, and so forth. Information also may be entered into device 700 by way of microphone. Such information may be digitized by a voice recognition device. The embodiments are not limited in this context.

Device 700 may comprise a user interface 710 that may be displayed on display 704 similar to user interface 100 and/or skip function user interface 202 discussed herein.

Various embodiments may be implemented using hardware elements, software elements, or a combination of both. Examples of hardware elements may include processors, microprocessors, circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), logic gates, registers, semiconductor device, chips, microchips, chip sets, and so forth. Examples of software may include software components, programs, applications, computer programs, application programs, system programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints.

Some embodiments may be described using the expression “coupled” and “connected” along with their derivatives. These terms are not intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

Some embodiments may be implemented, for example, using a machine or tangible computer-readable medium or article which may store an instruction or a set of instructions that, if executed by a machine, may cause the machine to perform a method and/or operations in accordance with the embodiments. Such a machine may include, for example, any suitable processing platform, computing platform, computing device, processing device, computing system, processing system, computer, processor, or the like, and may be implemented using any suitable combination of hardware and/or software. The machine-readable medium or article may include, for example, any suitable type of memory unit, memory device, memory article, memory medium, storage device, storage article, storage medium and/or storage unit, for example, memory, removable or non-removable media, erasable or non-erasable media, writeable or re-writeable media, digital or analog media, hard disk, floppy disk, Compact Disk Read Only Memory (CD-ROM), Compact Disk Recordable (CD-R), Compact Disk Rewriteable (CD-RW), optical disk, magnetic media, magneto-optical media, removable memory cards or disks, various types of Digital Versatile Disk (DVD), a tape, a cassette, or the like. The instructions may include any suitable type of code, such as source code, compiled code, interpreted code, executable code, static code, dynamic code, encrypted code, and the like, implemented using any suitable high-level, low-level, object-oriented, visual, compiled and/or interpreted programming language.

Unless specifically stated otherwise, it may be appreciated that terms such as “processing,” “computing,” “calculating,” “determining,” or the like, refer to the action and/or processes of a computer or computing system, or similar electronic computing device, that manipulates and/or transforms data represented as physical quantities (e.g., electronic) within the computing system's registers and/or memories into other data similarly represented as physical quantities within the computing system's memories, registers or other such information storage, transmission or display devices. The embodiments are not limited in this context.

Numerous specific details have been set forth herein to provide a thorough understanding of the embodiments. It will be understood by those skilled in the art, however, that the embodiments may be practiced without these specific details. In other instances, well-known operations, components and circuits have not been described in detail so as not to obscure the embodiments. It can be appreciated that the specific structural and functional details disclosed herein may be representative and do not necessarily limit the scope of the embodiments.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

1. An apparatus, comprising:
a processor to receive a control signal from a navigation controller and to display a skip function user interface on a display device, wherein the skip function user interface is used to navigate aggregated content items, wherein the skip function user interface comprises one or more skip boxes and wherein each of the one or more skip boxes is associated with a content item in the aggregated content items.

2. The apparatus of claim 1, wherein the aggregated content items are associated with a personal channel.

3. The apparatus of claim 1, wherein each of the one or more skip boxes is populated with metadata associated with a content item in the aggregated content items.

4. The apparatus of claim 3, wherein the metadata includes at least one of a visual cue and text related to the respective content item.

5. The apparatus of claim 1, wherein the skip function user interface allows a user to skip through the skip boxes to reach a desired content item.

6. The apparatus of claim 1, wherein the navigation controller is a remote control device.

7. The apparatus of claim 1, wherein the display device is a television.

8. A method, comprising:
displaying a skip function user interface on a display device; and
navigating aggregated content items via the skip function user interface, wherein the skip function user interface comprises one or more skip boxes and wherein each of the one or more skip boxes is associated with a content item in the aggregated content items.

9. The method of claim 8, wherein the aggregated content items are associated with a personal channel.

10. The method of claim 8, wherein each of the one or more skip boxes is populated with metadata associated with a content item in the aggregated content items.

11. The method of claim 10, wherein the metadata includes at least one of a visual cue and text related to the respective content item.

12. The method of claim 8, wherein the skip function user interface allows a user to skip through the skip boxes to reach a desired content item.

13. The method of claim 8, wherein the navigation controller is a remote control device.

14. The method of claim 8, wherein the display device is a television.

15. A machine-readable medium containing instructions which, when executed by a processing system, cause the processing system to perform a method, the method comprising:
displaying a skip function user interface on a display device; and
navigating aggregated content items via the skip function user interface, wherein the skip function user interface comprises one or more skip boxes and wherein each of the one or more skip boxes is associated with a content item in the aggregated content items.

16. The machine-readable medium of claim 15, wherein the aggregated content items are associated with a personal channel.

17. The machine-readable medium of claim 15, wherein each of the one or more skip boxes is populated with metadata associated with a content item in the aggregated content items.

18. The machine-readable medium of claim 17, wherein the metadata includes at least one of a visual cue and text related to the respective content item.

19. The machine-readable medium of claim 15, wherein the skip function user interface allows a user to skip through the skip boxes to reach a desired content item.

20. The machine-readable medium of claim 15, wherein the navigation controller is a remote control device and the display device is a television.
